(19) United States
(12) Patent Application Publication
(10) Pub. No.: US 2023/0201957 A1
(43) Pub. Date: Jun. 29, 2023

(54) METHOD FOR MONITORING AND/OR CONTROLLING IN A CLOSED LOOP A LASER WELDING PROCESS ON THE BASIS OF OCT-CAPTURED MELT BEAD OR WELD BEAD GEOMETRY AND ASSOCIATED PROCESSING MACHINE AND COMPUTER PROGRAM PRODUCT

(71) Applicant: TRUMPF Laser GmbH, Schramberg (DE)

(72) Inventors: Nicolai Speker, Pleidelsheim (DE); Oliver Bocksrocker, Sachsenheim (DE); Bjoern Sautter, Stuttgart (DE); Jan-Patrick Hermani, Markgroeningen (DE)

(21) Appl. No.: 18/171,391

(22) Filed: Feb. 20, 2023

Related U.S. Application Data
(63) Continuation of application No. PCT/EP2021/071747, filed on Aug. 4, 2021.

(30) Foreign Application Priority Data
Aug. 26, 2020 (DE) 10 2020 210 778.5

(51) Int. Cl. B23K 26/03; B23K 31/12

(52) U.S. Cl. CPC B23K 26/032; B23K 31/125; G01B 9/02091

(57) ABSTRACT

A method for monitoring and/or controlling in a closed loop a laser welding process for welding together two workpieces of metallic material includes, during the laser welding process, scanning a melt pool and/or a melt bead using an optical coherence tomography (OCT) measurement beam in at least one line scan, determining an actual geometry of the melt pool and/or the melt bead based on the at least one line scan, and setting at least one welding parameter controlled in the closed loop based on a deviation of the actual geometry from a target geometry of the melt pool and/or the melt bead.

### CROSS REFERENCE TO RELATED APPLICATIONS

This application is a continuation of International Application No. PCT/EP2021/071747 (WO 2022/043012 A1), filed on Aug. 4, 2021, and claims benefit to German Patent Application No. DE 10 2020 210 778.5, filed on Aug. 26, 2020. The aforementioned applications are hereby incorporated by reference herein.

### FIELD

Embodiments of the present invention relate to a method for monitoring and/or controlling in a closed loop a laser welding process for welding together two workpieces of metallic material, in particular of copper or aluminum, preferably of two bar-type conductors, by means of a processing laser beam that is directed at end faces of the workpieces that are arranged next to one another in order to melt a melt pool at the two end faces and, in the further process, a melt bead, which then solidifies to form a weld bead. The end faces of the workpieces at which the processing laser beam is directed are preferably arranged in each case at the same level next to one another. Embodiments of the present invention also relate to a processing machine suitable for carrying out this method and to an associated computer program product.

### BACKGROUND

Bent bar-type conductors containing copper, in particular what are known as hairpins, are installed in electrodynamic machines, such as electric motors or generators. The bar-type conductors are arranged in accordance with an envisaged electrical interconnection and are welded to one another in order thus to construct an electromagnet. In this case, an electric motor typically comprises several dozen, often hundreds, of bent bar-type conductors that have to be welded to one another in pairwise fashion. What is important here is to provide a sufficient cross-sectional area by means of the weld, through which the electric current can flow from one bar-type conductor to the other bar-type conductor (“attachment area”). If the attachment area is too small, there is a risk of significant

ohmic heating, a loss of efficiency, or even uselessness of the electrodynamic machine during the operation.

The bar-type conductors are welded to one another by means of a laser beam, which for this purpose is typically directed at the end-side end faces of two bar-type conductors that are arranged next to each other, usually so as to be in contact with one another. The end faces are melted by the heat that is introduced and, after solidification, are connected to one another via a re-solidified melt bead. As a rule, the laser beam is always directed at the bar-type conductors with the same power for the same amount of time, as a result of which a sufficiently large attachment area is obtained.

However, the reflectivity of the bar-type conductors for the laser beam, and hence also the actual energy input, may vary on account of contamination or roughness on the surface of the bar-type conductors. Likewise, incorrect positioning of the bar-type conductors, for instance gaps or an offset, or an inaccurate positioning of the laser beam may lead to a variation in the actual energy input. If the energy input is too low, not enough material is melted and so this leads to the creation of a melt bead that is too small and provides an attachment area that is too small. The event of significant spatter formation during the laser welding may also lead to the creation of a melt bead that is too small and has an attachment area which is too small. The attachment area can be checked only subsequently by way of destructive testing or computed tomography (CT) or x-ray technology. Generally therefore a visual check is performed by the worker, or randomly selected samples are evaluated cyclically using CT or x-ray technology. Reworking the faulty parts is very complex.

DE 10 2014 226 710 A1 discloses the monitoring of hairpins by means of sensors that measure the extent of the melt pool and that can in this way detect whether the welding process is proceeding within the specified boundaries. Moreover, further sensors are used that test the solidified weld seam and can differentiate between good and bad seams.

Furthermore, DE 10 2014 113 283 A1 discloses point distance sensors for a coaxial measurement method, in particular for optical coherence tomography, in order to capture an analysis region on the workpiece for performing quality checks.

DE 10 2016 109 909 A1 describes an apparatus for process monitoring during laser processing, in particular during laser welding and deep penetration laser welding, by means of optical distance measurement. The distance measurement can be performed here for example by way of optical coherence tomography.

### SUMMARY

Embodiments of the present invention provide a method for monitoring and/or controlling in a closed loop a laser welding process for welding together two workpieces of metallic material. The laser welding process uses a processing laser beam that is directed at end faces of the two workpieces arranged next to one another in order to melt a melt pool at the end faces. In the laser welding process, the melt pool forms a melt bead. The melt bead then solidifies to form a weld bead. The method includes, during the laser welding process, scanning the melt pool and/or the melt bead using an optical coherence tomography (OCT) measurement beam in at least one line scan, determining an actual geometry of the melt pool and/or the melt bead based on the at least one line scan, and setting at least one welding parameter controlled in the closed loop based on a deviation of the actual geometry from a target geometry of the melt pool and/or the melt bead.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a processing machine according to embodiments of the present invention for laser welding two bar-type conductors; and

FIGS. 2a and 2b show the end faces of two bar-type conductors that are to be welded to each other with a molten melt pool (FIG. 2a) and a molten melt bead (FIG. 2b); and

FIG. 3 shows the welded-together end faces of two bar-type conductors with a solidified melt bead.

### DETAILED DESCRIPTION

Embodiments of the present invention provide a method for monitoring the laser welding process for welding together two workpieces which can be performed easily, quickly and in a destruction-free manner and of specifying a method for closed-loop control of the laser welding process in order to ensure an attachment area that is always sufficiently large.

In the method according to embodiments of the present invention, during the laser welding process, the liquid melt pool and the liquid melt bead are scanned by means of an optical coherence tomography (OCT) measurement beam in at least one line scan, an actual geometry of the melt pool and/or the melt bead is determined on the basis of the at least one line scan, and at least one welding parameter is set, in particular controlled in a closed loop, on the basis of a deviation of the determined actual geometry from a specified target geometry of the melt pool and the liquid melt bead, and/or that after the laser welding process the solidified weld bead is scanned by means of an OCT measurement beam in at least one line scan, an actual geometry of the weld bead is determined on the basis of the at least one line scan, and the quality of the weld bead is monitored on the basis of a deviation of the determined actual geometry from a specified target geometry of the weld bead.

According to some embodiments, the actual geometry of the melt pool, of the melt bead and/or the weld bead is scanned in one or more line scans using the OCT measurement beam, and preferably at least one of the following actual geometry features of the melt pool, the melt bead and/or the weld bead is determined therefrom:
diameter and/or roundness of the melt pool,
diameter, height and/or curvature of the melt bead, and
diameter, height and/or curvature of the weld bead.

The attachment area can be ascertained or deduced on the basis of the deviation of the determined actual geometry from a specified target geometry of the melt pool, the melt bead and/or the weld bead.

If the determined actual diameter of the solidified melt bead is smaller than the target diameter specified for a perfect melt bead or if the outer contour of the solidified melt bead is too non-circular, the attachment area of the solidified melt bead is too small and the melt bead is classified as being defective. If the determined actual height of the solidified melt bead is less than the target height specified for a perfect melt bead, or if the determined actual curvature of the solidified melt bead deviates from the target curvature specified for a perfect melt bead, for example from the target spherical cap-shaped curvature, the melt bead is classified as being defective.

If during the laser welding process the determined at least one actual geometry feature of the melt pool or the melt bead deviates from the specified target geometry feature, it is possible to counteract this by changing a welding parameter. For example, if the determined actual diameter of the melt pool or of the melt bead is smaller than the target diameter specified for the respective measurement time point, extending the welding parameter “welding duration” can still lead to a sufficiently large attachment area of the solidified weld bead being achieved.

The OCT scan by means of the OCT measurement beam is preferably performed in at least two different line scans, in particular line scans that are performed at right angles to one another, in order to three-dimensionally capture the actual geometry.

In the event of a weld bead being classified as being defective, the weld bead can automatically be re-welded or another action, in particular an alert, can be triggered. The immediate re-welding does not constitute a complex reworking of defective parts.

A processing machine according to embodiments of the present invention for laser welding together two workpieces of metallic material, in particular of copper or aluminum, preferably of bar-type conductors, by means of a processing laser beam comprises a laser beam generator for generating the processing laser beam, a laser scanner for two-dimensionally deflecting the processing laser beam onto end faces of two workpieces that are located next to one another in order to melt a melt pool at the two end faces and, in the further process, a melt bead which then solidifies to form a weld bead (9′), an optical coherence tomography (OCT) device for generating an OCT measurement beam which is directed by the laser scanner at the two end faces, an OCT scanner, arranged between the coherence tomography device and the laser scanner, for two-dimensionally deflecting the OCT measurement beam onto the two end faces in order to scan the melt pool, the melt bead and/or the weld bead by means of the OCT measurement beam in at least one line scan, a machine controller for controlling the laser scanner and the OCT scanner, an evaluation device for determining an actual geometry of the melt pool, of the melt bead and/or of the weld bead on the basis of the at least one line scan, and a setting device for setting, in particular controlling in a closed loop, at least one welding parameter on the basis of a deviation of the determined actual geometry from a specified target geometry of the melt pool and/or of the melt bead, and/or a monitoring device for monitoring the quality of the weld bead on the basis of a deviation of the determined actual geometry from a specified target geometry of the weld bead. The machine controller is programmed to control, during and/or after the laser welding process, the OCT scanner in order to scan the end faces of the workpieces by means of the OCT measurement beam in at least one line scan.

Embodiments of the present invention also relate to a computer program product comprising code means adapted for carrying out all of the steps of the method according to the invention when the program runs on a machine controller of a processing machine.

Further advantages and advantageous configurations of the subject matter of the invention can be gathered from the description, the drawings and the claims. Likewise, the features mentioned above and those that are yet to be presented can be used in each case by themselves or as a plurality in any desired combinations. The embodiments shown and described should not be understood as an exhaustive enumeration, but rather are of exemplary character for outlining the invention.

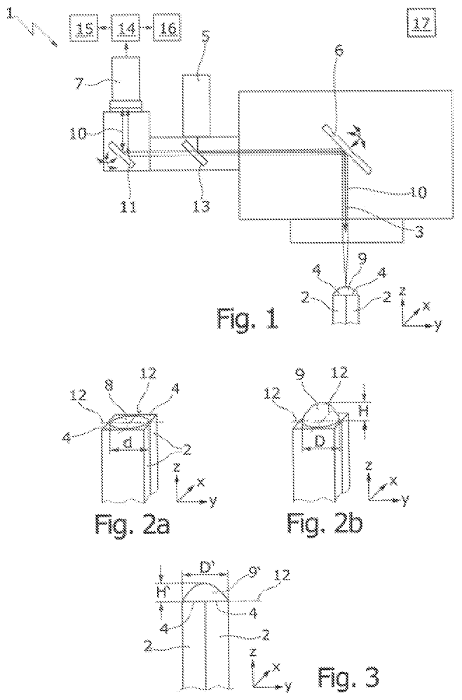

The processing machine 1 shown schematically in FIG. 1 serves for laser welding together two workpieces of metallic material, in the present case by way of example in the form of two bent bar-type conductors 2 (“hairpins”) made of copper, by means of a processing laser beam 3. The two bar-type conductors 2 have the same end face 4 to be welded having the same cross-sectional area and their end faces 4 are arranged at the same level next to each other.

The laser processing machine 1 comprises a laser beam generator 5 for generating the processing laser beam 3, a laser scanner 6 for two-dimensionally deflecting the processing laser beam 3 in x-, y-directions onto the end faces 4 of the workpieces 2, and an optical coherence tomography (OCT) device 7 for optically scanning the end faces 4 of the workpieces 2. The laser scanner 6 can have for example one scanner mirror deflectable about two axes, or two scanner mirrors each deflectable about one axis.

As shown in FIGS. 2a, 2b, a common, initially planar, melt pool 8 is melted by means of the processing laser beam 3 at the two end faces 4, from which melt pool, in the further welding process, a molten melt bead 9 is formed, which then solidifies to form a weld bead. FIG. 3 shows the two welded-together bar-type conductors 2, whose end faces 4 are integrally joined together by way of the solidified weld bead 9′.

The OCT 7 has in a known manner an OCT light source (e.g. superluminescence diode) for generating a light beam, an OCT beam splitter for splitting the light beam into an OCT measurement beam 10 and an OCT reference beam. The OCT measurement beam 10 is forwarded to a measuring arm and is incident on the end faces 4 of the workpieces 2, at which the OCT measurement beam 10 is at least partly reflected and guided back to the OCT beam splitter, which is nontransmissive or partly transmissive in this direction. The OCT reference beam is forwarded to a reference arm and reflected by a mirror at the end of the reference arm. The reflected OCT reference beam is likewise guided back to the OCT beam splitter. The superposition of the two reflected beams is finally detected by a detector (OCT sensor) in order to ascertain, by taking account of the length of the reference arm, height information about the end faces 4 of the workpieces 2. This method is based on the fundamental principle of the interference of light waves and makes it possible to detect height differences along the measurement beam axis in the micrometer range.

An OCT (small field) scanner 11 is arranged in the beam path of the OCT measurement beam 8 in order to two-dimensionally, that is to say in x-, y-directions, deflect the OCT measurement beam 10 onto the end faces 4 of the workpieces 2 and in this way to scan the end faces 4 of the workpieces 2 with one or more line scans 12 (FIGS. 2a, 2b). The OCT scanner 11 can have for example one scanner mirror deflectable about two axes, or two scanner mirrors each deflectable about one axis. Using a beam splitter (for example in the form of a dichroic mirror) 13, which is arranged obliquely in the beam path of the processing laser beam 3 and is reflective for the processing laser beam 3 and transmissive for the OCT measurement beam 10, the OCT measurement beam 10 is coupled into the laser scanner 6—in the zero positions of the two scanners 6, 11 coaxially to the processing laser beam 3—in order to direct the OCT measurement beam 10 at the end faces 4 of the workpieces 2.

The line scan data of the OCT 7 are forwarded to an evaluation device 14, which determines an actual geometry of the melt pool 8, of the melt bead 9 and of the weld bead 9′ on the basis of the one or more line scans 12. Preferably, the actual geometry determined is one of the following actual geometry features of the melt pool 8, of the melt bead 9 and of the weld bead 9′:
diameter d and/or roundness of the melt pool 8,
diameter D, height H and/or curvature of the melt bead 9, and
diameter D′, height H′ and/or curvature of the weld bead 9′.

The determined actual geometry of the melt pool 8 and of the melt bead 9 is forwarded to a setting device 15, which accordingly sets, in particular controls in a closed loop, a welding parameter, such as the welding duration, on the basis of a deviation of the determined actual geometry from a specified target geometry of the melt pool 8 and of the melt bead 9. For example, if the determined actual diameter d, D of the melt pool 8 or of the melt bead 9 is smaller than the target diameter specified for the respective measurement time point, extending the welding duration can still lead to a sufficiently large attachment area of the solidified weld bead 9′ being achieved.

The determined actual geometry of the solidified weld bead 9′ is forwarded to a monitoring device 16, which monitors the quality of the weld bead 9 on the basis of a deviation of the determined actual geometry from a specified target geometry of the weld bead 9′. If the deviation lies outside a specified tolerance, the weld bead 9′ is classified as being defective, and the welded bar-type conductors 2 are removed. If an attachment area is too small, it is also possible to immediately re-weld until the attachment area lies within the tolerances, because the welded bar-type conductors 2 are still in the welding position.

A machine controller 17 controls the movement of the scanners 6, 11 and is programmed to control, during and/or after the laser welding process, the OCT scanner 11 in order to scan the end faces 4 of the workpieces 2 by means of the OCT measurement beam 10 in one or more line scans 12.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring and/or controlling in a closed loop a laser welding process for welding together two workpieces of metallic material using a processing laser beam that is directed at end faces of the two workpieces arranged next to one another in order to melt a melt pool at the end faces, wherein in the laser welding process, the melt pool forms a melt bead, and the melt bead then solidifies to form a weld bead, the method comprising:
during the laser welding process:
scanning the melt pool and/or the melt bead using an optical coherence tomography (OCT) measurement beam in at least one line scan,
determining an actual geometry of the melt pool and/or the melt bead based on the at least one line scan, and
setting at least one welding parameter controlled in the closed loop based on a deviation of the actual geometry from a target geometry of the melt pool and/or the melt bead.

2. The method as claimed in claim 1, further comprising:
after the laser welding process:
scanning the weld bead using a second OCT measurement beam in at least a second line scan,
determining an actual geometry of the weld bead based on the second line scan, and
monitoring a quality of the weld bead based on a deviation of the actual geometry of the weld bead from a target geometry of the weld bead.

3. The method as claimed in claim 1, wherein scanning the melt pool and/or the melt bead using the OCT measurement beam is performed in at least two different line scans that are at right angles with respect to one another.

4. The method as claimed in claim 1, wherein the actual geometry of the melt pool comprises at least one of the following actual geometry features:
a diameter and a roundness of the melt pool.

5. The method as claimed in claim 1, wherein the actual geometry of the meld bead comprises at least one of the following actual geometry features:
a diameter, a height and a curvature of the melt bead.

6. The method as claimed in claim 2, wherein the actual geometry of the weld bead comprises at least one of the following actual geometry features:
a diameter, a height and a curvature of the weld bead.

7. The method as claimed in claim 1, further comprising:
upon determining that the weld bead is defective, automatically re-welding the weld bead or triggering an alert.

8. The method as claimed in claim 1, wherein the at least one welding parameter comprises a welding duration.

9. A processing machine for laser welding two workpieces of metallic material using a processing laser beam, the processing machine comprising:
a laser beam generator for generating the processing laser beam,
a laser scanner for deflecting the processing laser beam two-dimensionally onto end faces of the two workpieces that are positioned next to one another in order to melt a melt pool at the end faces, wherein in a laser welding process, the melt pool forms a melt bead, and the meld bead then solidifies to form a weld bead,
an optical coherence tomography (OCT) device for generating an OCT measurement beam to be directed by the laser scanner at the end faces of the two workpieces,
an OCT scanner, arranged between the OCT device and the laser scanner, for deflecting the OCT measurement beam two-dimensionally onto the end faces of the two workpieces in order to scan the melt pool, and/or the melt bead, and/or the weld bead using the OCT measurement beam in at least one line scan,
a machine controller for controlling the laser scanner and the OCT scanner,
an evaluation device for determining an actual geometry of the melt pool, and/or of the melt bead, and/or of the weld bead based on the at least one line scan,
a setting device for setting, in a closed loop, at least one welding parameter based on a deviation of the actual geometry from a target geometry of the melt pool and/or of the melt bead.

10. The processing machine as claimed in claim 9, further comprising a monitoring device for monitoring a quality of the weld bead based on a deviation of the actual geometry of the weld bead from a target geometry of the weld bead,
wherein the machine controller is programmed to control, during and/or after the laser welding process, the OCT scanner in order to scan the end faces of the two workpieces using the OCT measurement beam in the at least one line scan.

11. A computer program product comprising instructions for performing the method as claimed in claim 1 when the computer program product runs on a machine controller of a processing machine.
